(19) United States
(12) Patent Application Publication
(10) Pub. No.: US 2014/0282868 A1
(43) Pub. Date: Sep. 18, 2014

(54) Method And Apparatus To Effect Re-Authentication

(71) Applicants: Micah Sheller, Hillsboro, OR (US); Christopher Gutierrez, West Lafayette, IN (US); Conor Cahill, Waterford, VA (US); Jason Martin, Beaverton, OR (US); Brandon Baker, Hillsboro, OR (US)

(72) Inventors: Micah Sheller, Hillsboro, OR (US); Christopher Gutierrez, West Lafayette, IN (US); Conor Cahill, Waterford, VA (US); Jason Martin, Beaverton, OR (US); Brandon Baker, Hillsboro, OR (US)

(21) Appl. No.: 13/832,556

(22) Filed: Mar. 15, 2013

(51) Int. Cl. G06F 21/31

(52) U.S. Cl. CPC G06F 21/31
USPC 726/3

(57) ABSTRACT

A system is provided to determine whether to re-authenticate a user based on identification parameter measurements of low power sensors. According to an embodiment of the invention, a system may include a processor that includes analysis logic to determine whether to re-authenticate the user based on parameter values received from at least one of one or more agents. The system may also include authentication logic to re-authenticate the user that includes a confirmation of whether the user is authenticated based on input received from one or more authentication sensors. Other embodiments are described and claimed.

### FIELD OF THE INVENTION

The field of the invention is authentication of a user of a computer system.

### BACKGROUND

During an authenticated user session, re-authentication of a user can ensure that security of interactions of the user will be maintained throughout the user session. Re-authentication may be triggered by, e.g., idle timeout. If an idle timeout threshold is set at a short time period, the result can be that re-authentication occurs frequently, which can temporarily disable the session. The user may find that such frequent re-authentication interferes with efficient use of time and computing resources. Further, re-authentication can be an energy intensive process, which is not optimal in portable equipment such as portable computers, smart phones, and other battery-operated devices. However, if the idle timeout threshold is set to a long time period, security of the session may be compromised because re-authentication occurs infrequently.

### BRIEF DESCRIPTION OF THE DRAWINGS

FIG. 1 is a block diagram of a system to re-authenticate a user, in accordance with an embodiment of the present invention.

FIG. 2 is a block diagram of a system to re-authenticate a user, in accordance with another embodiment of the present invention.

FIG. 3 shows a method of determining whether to re-authenticate a user, in accordance with an embodiment of the present invention.

FIG. 4 is a block diagram of a system arrangement in accordance with an embodiment of the present invention.

FIG. 5 is a block diagram of an example system with which embodiments of the present invention can be used.

FIG. 6 is a block diagram of components present in a computer system in accordance with an embodiment of the present invention.

### DETAILED DESCRIPTION

Embodiments of the present invention include a platform service that uses trusted platform agents to determine when a re-authentication should take place through various metrics. As an example metric, if user a typing pattern changes significantly during a session, a re-authentication could be triggered.

Embodiments of the present invention may enable power savings by employing low-power platform sensors/software agents for continuous or periodic monitoring, while using high-power, hi-fidelity authentication sensors only when sufficient evidence is gathered that indicates that re-authentication is warranted.

Determination of whether to re-authenticate a user (as opposed to, e.g., repeatedly asking whether the user is at the system) can be through use of passive trusted agents that can monitor some or all of ephemeral biometrics (e.g., a color-sensor tracking the user's shirt), weak biometrics (e.g., mouse or keypress (e.g., keyboard, touchscreen) dynamics), and access to sensitive platform files (e.g., encrypted files) or services (e.g., network). If data from one or more of the trusted agents indicates that a determination of whether the user is at the system is warranted, re-authentication can be invoked.

In an embodiment of the present invention, the user is initially authenticated. In an example laptop computer system, authentication on the laptop computer may be through use of a high-resolution camera to perform facial recognition. (Alternatively or in addition, other authentication techniques, e.g., fingerprint detection, iris metrics, etc. may be used to authenticate. Upon completion of the authentication, the high-resolution camera or other sensor may be turned off (e.g., powered off) to conserve power. Thereafter, trusted agents on the laptop computer may measure various user information, such as colors of the user's shirt (via an ultra-low power color sensor), keypress and mouse dynamics, and/or access to encrypted files. As used herein, a trusted agent is an entity in the form of hardware, software, or firmware (or a combination thereof) that is isolated or protected from malicious intrusion by, e.g., protective hardware, software, firmware, or combinations thereof. Trusted agents may receive data from sensors operable with low power requirements in comparison to other authentication sensors, e.g., high-resolution cameras. Therefore, trusted agents may provide data on a continual or periodic basis while maintaining a low energy usage over time. Although the scope of the present invention is not limited in this regard, sensors that provide data to the trusted agents may include low resolution cameras (e.g., single pixel camera to detect color changes), motion detectors, ambient temperature sensors, mouse motion sensors, keyboard sensors, etc. Additionally, sensors that monitor typing behavior (e.g., typing speed), access to restricted files, access to restricted networks, etc. may be monitored by corresponding trusted agents.

At some point, the user may be replaced with a malicious user. One or more of the trusted platform agents may report that the shirt color is not a match to a previously detected color, e.g., at the time that the original authentication took place, and/or that the keypress/mouse dynamics are unusual for the user, and/or that secure files are being requested via the laptop. Evaluation of data provided by the trusted agents may indicate a sufficiently unusual/risky set of events that triggers a re-authentication. The high-resolution camera may be turned on, e.g., powered up, to effect the re-authentication, and detects the malicious user. Consequently, the session is closed.

A similar method could apply to a phone, tablet computer, Ultrabook™, server, or desktop computer, using the same types of sensors, similar sensors, or other sensors or behavioral analysis agents.

Components of the system to determine whether to conduct re-authentication can include an authentication entity such as a hardened client operating system (OS) or remote server to evaluate whether the trusted agent data warrants a re-authentication, and trusted agents to collect and analyze measurements used to determine a confidence level of whether the authenticated user is still at the system. Typically, the trusted agent output does not need to be as accurate as a typical authentication factor, e.g., false rejects are easily tolerated. The use of trusted agents to monitor data related to user identification may be advantageous where the re-authentication is transparent to the user but re-authentications may be limited for power/performance reasons. In contrast, passive authentication mechanisms, such as timeout-based solutions, may interrupt a user session and may be power intensive.

In comparison to timeout-based solutions, embodiments actively monitor for signs of change in the user and can close user sessions that have been usurped. Additionally, the trusted agents require less reliability than typical authentication agents, resulting in a lower apparatus cost.

The costs of erroneous results from the trusted agents can include 1) a user session is erroneously extended, 2) a re-authentication is erroneously triggered. In the case of the user session erroneously extended, existing timeout policies may provide a backup mechanism to trigger re-authentication. In the case of an erroneous trigger, the re-authentication can result in additional inconvenience for the user.

Use of less reliable but lower power consumption methods to drive the rate of re-authentication can result in a less frequent use of the higher-cost and power intensive authentication factors as compared with, e.g., idle time-out methods. Additional advantages may include reduction in opportunities for the soft-biometrics/behavior analyzers to be spoofed through use of trusted agents, and monitoring of other user behaviors such as encrypted file access, network access, etc.

In an embodiment of the present invention, the system employs technologies such as Secure Enclaves, as well as secure channels between the sensors and the Secure Enclaves software. Secure Enclaves (SE) is a technology that enables applications to protect parts of their code and data by placing them inside an “enclave.” An enclave is able to maintain confidentiality and integrity of the code/data that it contains, protecting the code/data from software attacks, including attacks from the OS and other enclaves, as well as hardware memory attacks. Additionally, SE provides powerful security features for storage and attestation to local/remote entities.

In an embodiment, all channels are secured (e.g., through various techniques including but not limited to encryption, integrity-protection, replay-protection, and other techniques such as AES, SHA, sequence numbers, etc.), including channels to hardware including, e.g., sensors. Within the authentication agent (e.g., client-based authentication technology (CBAT), a remote server, and/or other authentication agent), trusted agent inputs can be combined via, e.g., a continuous multi-factor authentication system, to generate a confidence level. A confidence threshold (hereinafter “aggressiveness”) at which a re-authentication is triggered can be modified based on whether re-authentications are successful. For example, if the output of the trusted agents frequently resulted in re-authentications and those re-authentications repeatedly came back positive to indicate that the user remains authenticated, the aggressiveness may be reduced to avoid unnecessary power usage associated with re-authentication (e.g., through use of the power-intensive high resolution authentication camera, etc.).

A pseudo-code example of aggressiveness selection follows in Table 1.

TABLE 1
var confidence // initial value 1.0 after first auth
var aggressiveness // at what confidence level to trigger a re-auth
onInput(trusted_agent_input)

confidence := updateConfidence(trusted_agent_input, time, etc...)
if confidence < aggressiveness

if reauth( ) == true

confidence := 1.0
decreaseAggressiveness( )

else

// authentication failed. Take appropriate action, such as
locking system

The pseudocode in Table 1 sets a variable “confidence” (confidence level) at an initial value (e.g., confidence level set to initial value of 1.0) after first authentication, and sets another variable “aggressiveness” (confidence threshold). The confidence level may be updated based on input received from trusted agents over time. If the confidence level is less than the aggressiveness, and if the re-authentication process confirms authentication of the user, then a decrease of aggressiveness may be warranted in order to reduce frequency of re-authentication, which can in turn reduce power expended by authentication sensors. However, if the re-authentication fails to confirm authentication of the user, the system may be locked to prevent unauthorized use.

The trusted agents, e.g., input-dynamics and biometrics agents, may be notified of a change in aggressiveness in order to update any associated machine-learning algorithms. Through use of Secure Enclaves and related trusted input/output features, trusted platform agents may provide the security and usability benefits of continuous authentication without a need to continually sample high-power sensors or to re-gather low-usability user credentials such as passwords. Embodiments of the invention may be useful in, e.g., phones, where authentication requirements can severely intrude on usability. Embodiments of the present invention can provide a low-power/high-usability approach by reserving use of high-power/low-usability authentication methods to instances when weaker, cheaper methods, e.g., use of trusted agents and low power sensors, detect suspicious or risky conditions.

Embodiments of the present invention may include a system to determine when to re-authenticate a user. The system may include one or more trusted agents that include corresponding trusted agent logic. Each trusted agent may monitor one or more corresponding identification parameters. The system may also include a processor including analysis logic to determine whether to re-authenticate a user based on parameter values received from the one or more trusted agents, and the processor may include authentication logic to re-authenticate the user through authentication data received from one or more authentication sensors. In an embodiment, at least one of the authentication sensors is in a powered-up state while the user is being re-authenticated and in a powered-down state after the user is re-authenticated and during time periods between re-authentications.

Referring to FIG. 1, shown is a block diagram of a system 100 to re-authenticate a user, according to an embodiment of the present invention. The system 100 includes a processor 102, a co-processor 110, one or more sensors 116₀, . . . 116ₙ, and authentication sensor(s) 120.

The processor 102, which may be a multicore processor, may execute an operating system (OS) 104 that may include OS session management logic 106 and application/asset monitor logic 108. The coprocessor 110 may include authentication logic 118 and sensor data analysis logic 112 that may include one or more trusted agents 114₀, . . . , 114ₙ, each trusted agent 114ᵢ to receive corresponding input from one of the sensors 116ᵢ. The sensors 116₀, . . . , 116ₙ may include one or more of, e.g., a color sensor, a keyboard, mouse, accelerometer, touch sensor, or other types of sensors.

In operation, a user of the system 100 may be authenticated via the authentication logic 118 through, e.g., use of the authentication sensor(s) 120. For example, the authentication sensor 120 may be a high resolution camera to detect facial features of the user, which features may be compared, by the authentication logic 118, to biometric identification data associated with the user (e.g., recorded measurements of the user's facial features) and stored in a memory (not shown). Other biometric measurements, e.g., vein pattern recognition; iris, ear, voice recognition) and/or passwords, personal identification numbers (PINs), smart card or other physical token, etc., which may be compared to stored authentication data. The authentication logic 118 may indicate authentication of the user based on the comparison(s) of the stored authentication data to the data received from the authentication sensor(s) 120. Authentication of the user can enable access by the user to a session that permits access to restricted data, restricted files, restricted networks, restricted channels, etc., or a combination thereof. After authentication is complete, and between instances of re-authentication, one or more of the authentication sensors may be powered down, by, e.g., the authentication logic 118. That is, upon an indication to re-authenticate, the authentication logic 118 may power up one or more of authentication sensors 120 and after re-authentication is complete the authentication logic 118 may power down one or more of the authentication sensors 120.

Upon authentication, one or more of the sensors 116₀, . . . , 116ₙ may be activated by, e.g., the trusted agents 114₀, . . . , 114ₙ, to generate sensor data to be sent to a corresponding trusted agent 114₀, . . . , 114ₙ. In an embodiment, the sensor data may be sent by each of the sensors to the corresponding trusted agent continually. In another embodiment, the sensor data may be sent by each of the sensors to the corresponding trusted agent periodically.

Each trusted agent 114ᵢ may analyze the sensor data received from its corresponding sensor 116ᵢ and may detect anomalous data received from the sensor 116ᵢ, by a comparison with historical sensor data that is associated with the user. For example, a first trusted agent that receives input from a color sensor, e.g., a single pixel camera, may detect a color change that may be caused by a change of shirt color, which may be detectable by the color sensor. In another example, a second trusted agent may detect a change in a typing pattern of a current user as compared with historical typing pattern data associated with a first user.

In an embodiment, each of the trusted agents 114₀, . . . , 114ₙ may provide input to analysis logic 112 that may perform a multi-factor analysis using one or more algorithms such as Kalman filters, hidden Markov models, decision trees Bayesian networks, etc. e.g., through analysis of color data from a low resolution camera and/or other biometric sensors, analysis of typing characteristics, access to various data files and/or networks, etc., to arrive at a confidence level used to determine whether re-authentication is warranted. For example, if the confidence level falls below a confidence threshold, the re-authentication may be triggered. The confidence threshold may be initially set based on historical data. For instance, in one embodiment the confidence threshold may be set to a value at which there is a 90% confidence that re-authentication is not warranted.

The confidence threshold may be updated responsive to a count of successful re-authentications. For example, if re-authentications are frequently invoked and if the outcome of each re-authentication is a confirmation that an original user is still conducting a current session on the system, the confidence threshold may be reduced to reduce a sensitivity that triggers re-authentication. Reduction in the number of re-authentications may result in a reduction in energy expended to operate the authentication sensor(s) such as an energy intensive high-resolution camera, which may be used in re-authentication. In another example, if re-authentications happen only infrequently, the confidence threshold may be increased to increase the sensitivity that triggers the re-authentication.

Referring now to FIG. 2, shown is a block diagram of a system 200 to re-authenticate a user, according to an embodiment of the present invention. The system 200 includes a processor 202, one or more sensors 220₀, . . . , 220ₙ, and one or more authentication sensor(s) 230.

The processor 202 may include a secure container 204 that can include a remote session manager 206, sensor data analysis logic 208, and one or more trusted agents 214₀, . . . , 214ₙ, each trusted agent to couple to a corresponding sensor 220₀, . . . , 220ₙ. The processor 202 may also execute an operating system 210 that may include application/asset monitor logic 212. The remote session manager 206 may be coupled to a remote backend 240 (e.g., a remote server, e.g. cloud server or other remote server coupled to the system via a network, e.g., local area network or wide area network) that includes authentication logic 242 and session control 244.

In operation, a user may be authenticated through the authentication logic 242 within remote backend 240 via the remote session manager 206, the authentication effected through use of authentication data provided by the authentication sensor(s) 230. For example, the authentication sensor 230 may include a biometric device such as a camera. The authentication logic 242 may compare the authentication data to biometric identification data associated with the user, e.g., facial biometric data, and that may be stored in a memory (not shown). The authentication logic 216 may indicate authentication of the user based on the comparison(s). Use of the secure container 204 can ensure security of authentication data received.

Upon authentication, each trusted agent 214₀, . . . , 214ₙ may process sensor data from a corresponding sensor 226₀, . . . , 226ₙ. In an embodiment, the sensor data may be received from each of the sensors by the corresponding trusted agent on a continual basis. In another embodiment, the sensor data may be received from each of the sensors by the corresponding trusted agent on a periodic or an aperiodic basis.

Each trusted agent may analyze the sensor data received and may detect anomalous data, e.g., by comparison with historical sensor data that is associated with the user. For example, a first trusted agent that receives input from a color sensor, e.g., a single pixel camera, may detect a color change that may be caused by a change of shirt color detectable by the color sensor. In another example, a second trusted agent may detect a change in a typing pattern of a current user as compared with historical data associated with a first user.

In an embodiment, each of the trusted agents 214₀, . . . , 214ₙ may provide input to session data analysis logic 208. Additional data may be provided to the session data analysis logic 208 by the application/asset monitor logic 212, which can monitor events such as a launch of a program that may not be typically accessed by the original user, access to data not typically accessed by the original user, connection to a network that the original user may not typically access, and other potentially unexpected behavior, each of which may serve as evidence of a change of users. The session data analysis logic 208 may perform a multi-factor analysis to arrive at a confidence level used to determine whether re-authentication is warranted. For example, if the confidence level exceeds a confidence threshold, the re-authentication may be triggered. The confidence threshold may be initially set based on historical data or based on a policy.

If re-authentication is triggered, the authentication of the user may be repeated to verify that the current user is the same user that initiated a session currently under way. If the re-authentication process fails, e.g., the authentication logic 242 indicates that authentication is not verified (e.g., change of user detected by analysis of data received from the authentication sensor(s)), the session may be terminated.

In an embodiment, the confidence threshold may be updated responsive to a frequency of re-authentications that reiterate authentication of the user. For example, if re-authentications are frequently requested and if the outcome of each re-authentication is a confirmation that the (original) user is still conducting a current session on the system, the confidence threshold may be adjusted to reduce a frequency of re-authentication. Reduction in the number of re-authentications may result in a reduction in energy expended to operate the authentication sensor(s) that are used in re-authentication.

Referring to FIG. 3, shown is a flow diagram of a method to determine whether re-authentication is warranted, according to the present invention. The method may be executed by, e.g., a co-processor such as the co-processor 110 of FIG. 1, or by a system such as the system 200 of FIG. 2, or by another processor or system.

Beginning at block 302, a re-authentication threshold is set to an initial value, e.g., based on historical data and/or policy that may be set by, e.g., a system administrator. For example, the historical data may suggest an authentication threshold below which a re-authentication is typically warranted. The suggested confidence level may be adopted as an initial re-authentication threshold.

Continuing to block 304, a user is authenticated through use of authentication sensors (to measure, e.g., visual characteristics (facial, etc.), fingerprints, iris, retina, voice, odor, blood flow, DNA, ECG, EEG, etc.) that provide data to authentication logic for, e.g., comparison with an authentication standard. After authentication is complete, one or more of the authentication sensors may be powered down by, e.g., authentication logic. The one or more authentication sensors may be powered up on re-authentication and then powered down again after re-authentication is complete. At decision diamond 306, if authentication fails (e.g., user identity is not confirmed), advancing to block 320, the session is ended. Termination of the session may prevent user access to protected data, protected files, protected networks, and other secure content.

If the authentication of the user is confirmed at decision diamond 306, moving to decision diamond 308, if the authentication is a first authentication of a session, moving to block 309, a confidence level associated with re-authentication of the user is set to an initial value. In one example, the initial value of the confidence level may be set to a “dummy” value prior to a determination of the confidence level based on input from trusted agents. Proceeding to decision diamond 310, it may be determined whether to adjust a re-authentication threshold used to determine whether to re-authenticate. The re-authentication threshold may be adjusted based on a historical frequency of instances of re-authentication that have yielded confirmation of user authentication. That is, if re-authentication is conducted frequently and if the outcome of most or all of the re-authentications is that the authentication of the user is confirmed, adjustment (e.g., reduction) of the re-authentication threshold may be warranted to reduce a frequency of re-authentications and that can reduce usage of an authentication sensor (e.g., high resolution camera having a relatively large power consumption rate) and authentication logic, which can result in reduction in energy consumption. Or, if re-authentication is conducted infrequently, increase of the re-authentication threshold may be warranted. If adjustment of the re-authentication threshold is warranted, based on re-authentication history, moving to block 312 the re-authentication threshold may be adjusted.

Advancing to block 314, trusted agents collect and monitor sensor data from their respective sensors, e.g., ephemeral biometric data (e.g., data related to the user's shirt color, odor associated with the user at time of authentication, a wearable item detected at the time of authentication, etc.), weak biometric data (e.g., mouse or keypress dynamics from keyboard, touch screen, etc.), indications of access to restricted platform files or services, etc. Each trusted agent may collect and monitor data from one or more corresponding sensors. In various embodiments, data may be collected and monitored on a continuous basis, a periodic basis, an aperiodic basis, or any combination thereof.

Moving to block 316, a confidence level may be determined based on analysis of the data received from the trusted agents. For instance, the confidence level may be arrived at from a multi-factor analysis of the data collected and analyzed by the trusted agents. For example, each of the trusted agents may collect data from a corresponding sensor, e.g., low-power camera, typing sensor, mouse sensor, low-power biometric sensor, etc. For instance, each sensor may monitor a parameter that represents a characteristic of the user, e.g., shirt color, frequency of user motion, change of user position that may indicate a change of user, user typing characteristics, user mouse handling characteristics, access to specific files and/or network resources, etc. A given sensor may provide parameter values on a continual basis, a periodic basis (e.g., once per minute), an aperiodic basis (upon detection of a significant change in parameter value), etc.

Each trusted agent may provide one or more parameter values, based on the collected data, to sensor data analysis logic that can perform a multi-factor analysis to determine a confidence level, e.g., by a calculation based on the parameter values received from the trusted agents. For example, the calculation performed may be a sum, a weighted average of normalized parameter values (e.g., each of which have been normalized to a corresponding parameter standard), a majority vote, or another type of multi-factor analysis. Alternatively, another statistical analysis of the information provided by the trusted agents may be carried out and may yield a value of the confidence level.

Proceeding to block 318, the confidence level may be compared to the re-authentication threshold, and if the comparison indicates that re-authentication is warranted, control returns to block 304. If, at block 318, the comparison indicates that the re-authentication is not warranted, control returns to block 314 and the trusted agents continue to collect and monitor data from sensors. For example, if the confidence level exceeds the re-authentication threshold, no re-authentication of the user may occur, as the comparison indicates a high degree of confidence that the user has not changed. By not re-authenticating the user, power that would be expended to operation authentication sensors may be saved.

Referring now to FIG. 4, shown is a block diagram of a system arrangement in accordance with an embodiment of the present invention. As seen in FIG. 4, system 400 may include a core unit 410. In various embodiments, this core unit 410 may be a system on a chip (SoC) or other multicore processor and can include Secure Enclaves technology to enable a trusted execution environment.

As seen in the embodiment of FIG. 4, the core unit 410 may be coupled to a chipset 420. Although shown as separate components in the embodiment of FIG. 4, understand that in some implementations chipset 420 may be implemented within the same package as the core unit 410, particularly when the core unit 410 is implemented as an SoC. As seen, chipset 420 may include a manageability engine (ME) 425 including sensor analysis logic 428 to perform multi-factor authentication of sensor data to determine whether to re-authenticate a user, as described in various embodiments described herein. In an embodiment, the sensor data may be provided by, e.g., low-power sensors that may be monitored on an ongoing basis, which may reduce overall energy consumption associated with re-authentication of the user in comparison with energy consumption by authentication sensors such as high resolution cameras.

Note that although the sensor analysis logic 428 is shown as being within ME 425, understand that the scope of the present invention is not limited in this regard and the authentication can be performed in another location that also qualifies as a trusted execution environment. In an embodiment, sensor analysis logic 428 may be implemented within firmware of the ME 425.

In the embodiment of FIG. 4, additional components may be present including a sensor/communications hub 430 (in some embodiments may perform analysis and/or pre-filtering of sensor data), which may be a standalone hub or may be configured within chipset 420. As seen, one or more sensors 440 may be in communication with hub 430. As examples for purposes of illustration, the sensors may include inertial and environmental sensors (e.g., an accelerometer, force detector, single pixel camera, other weak biometric measurement devices, etc.) Also, in various embodiments one or more wireless communication modules 445 may also be present to enable communication with local or wide area wireless networks, such as a given cellular system in accordance with a 3G or 4G/LTE communication protocol.

As further seen in FIG. 4, platform 400 may further include user interfaces, namely user interfaces 495₁ and 495₂, which, in an example, can be a keyboard and a mouse respectively, and which may be coupled via an embedded controller 490 to the sensor/communications hub 430.

Embodiments can be used in many different environments. Referring now to FIG. 5, shown is a block diagram of an example system 500 with which embodiments can be used. As seen, system 500 may be a smartphone or other wireless communicator. As shown in the block diagram of FIG. 5, system 500 may include a baseband processor 510, which can include a security engine such as a manageability engine and other trusted hardware support to perform one or more user authentications, e.g., on boot up of the system, and further to perform user re-authentication, e.g., with a remote service provider, when warranted through analysis of low power sensor input from, e.g., sensors 520₀, . . . , 520ₙ, as described in various embodiments herein. In general, baseband processor 510 can perform various signal processing with regard to communications, as well as perform computing operations for the device. In addition, baseband processor 510 may couple to a memory system including, in the embodiment of FIG. 5 a non-volatile memory, namely a flash memory 530 and a system memory, namely a dynamic random access memory (DRAM) 535. As further seen, baseband processor 510 can couple to a capture device 540 such as an image capture device that can record video and/or still images.

To enable communications to be transmitted and received, various circuitry may be coupled between baseband processor 510 and an antenna 590. Specifically, a radio frequency (RF) transceiver 570 and a wireless local area network (WLAN) transceiver 575 may be present. In general, RF transceiver 570 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 580 may be present. Other wireless communications such as receipt or transmission of radio signals, e.g., AM/FM and other signals may also be provided. In addition, via WLAN transceiver 575, local wireless signals, such as according to a Bluetooth™ standard or an IEEE 802.11 standard such as IEEE 802.11a/b/g/n can also be realized. Although shown at this high level in the embodiment of FIG. 5, understand the scope of the present invention is not limited in this regard.

Referring now to FIG. 6, shown is a block diagram of components present in a computer system in accordance with an embodiment of the present invention. As shown in FIG. 6, system 600 can include many different components. In one embodiment, system 600 is a user equipment, touch-enabled device that incorporates a System on a Chip (SoC), e.g., Ultrabook™. Note that the components of system 600 can be implemented as ICs, portions thereof, discrete electronic devices, or other modules adapted to a circuit board such as a motherboard or add-in card of the computer system, or as components otherwise incorporated within a chassis of the computer system. Note also that the block diagram of FIG. 6 is intended to show a high level view of many components of the computer system. However, it is to be understood that additional components may be present in certain implementations and furthermore, different arrangement of the components shown may occur in other implementations.

As seen in FIG. 6, a processor 610, which may be a low power multicore processor socket such as an ultra-low voltage processor, may act as a main processing unit and central hub for communication with the various components of the system. Such processor can be implemented as a System on an Chip (SoC). In one embodiment, processor 610 may be an Intel® Architecture Core™-based processor such as an i3, i5, i7 or another such processor available from Intel Corporation, Santa Clara, Calif., such as a processor that combines one or more Core™-based cores and one or more Intel® ATOM™-based cores to thus realize high power and low power cores in a single SoC. However, understand that other low power processors such as available from Advanced Micro Devices, Inc. (AMD) of Sunnyvale, Calif., an ARM-based design from ARM Holdings, Ltd. or a MIPS-based design from MIPS Technologies, Inc. of Sunnyvale, Calif., or their licensees or adopters may instead be present in other embodiments such as an Apple A5 or A6 processor.

Processor 610 may communicate with a system memory 615, which in an embodiment can be implemented via multiple memory devices to provide for a given amount of system memory. To provide for persistent storage of information such as data, applications, one or more operating systems and so forth, a mass storage 620 may also couple to processor 610. Also shown in FIG. 6, a flash device 622 may be coupled to processor 610, e.g., via a serial peripheral interface (SPI). This flash device may provide for non-volatile storage of system software, including a basic input/output software (BIOS) as well as other firmware of the system.

Various input/output (IO) devices may be present within system 600. Specifically shown in the embodiment of FIG. 6 is a display 624 which may be a high definition LCD or LED panel configured within a lid portion of the chassis. This display panel may also provide for a touch screen 625, e.g., adapted externally over the display panel such that via a user's interaction with this touch screen, user inputs can be provided to the system to enable desired operations, e.g., with regard to the display of information, accessing of information and so forth. In one embodiment, display 624 may be coupled to processor 610 via a display interconnect that can be implemented as a high performance graphics interconnect. Touch screen 625 may be coupled to processor 610 via another interconnect, which in an embodiment can be an I²C interconnect. As further shown in FIG. 6, in addition to touch screen 625, user input by way of touch can also occur via a touch pad 630 which may be configured within the chassis and may also be coupled to the same I²C interconnect as touch screen 625.

For perceptual computing and other purposes, various sensors may be present within the system and can be coupled to processor 610 in different manners. Certain inertial and environmental sensors may couple to processor 610 through a sensor hub 640, e.g., via an I²C interconnect. In the embodiment shown in FIG. 6, these sensors may include an accelerometer 641, an ambient light sensor (ALS) 642, a compass 643 and a gyroscope 644. Other environmental sensors may include one or more thermal sensors 646 which may couple to processor 610 via a system management bus (SMBus) bus, in one embodiment.

Also seen in FIG. 6, various peripheral devices may couple to processor 610 via a low pin count (LPC) interconnect. In the embodiment shown, various components can be coupled through an embedded controller 635. Such components can include a keyboard 636 (e.g., coupled via a PS2 interface), a fan 637, and a thermal sensor 639. In some embodiments, touch pad 630 may also couple to EC 635 via a PS2 interface. In addition, a security processor such as a trusted platform module (TPM) 638 in accordance with the Trusted Computing Group (TCG) TPM Specification Version 1.2, dated Oct. 2, 2003, may also couple to processor 610 via this LPC interconnect.

System 600 can communicate with external devices in a variety of manners, including wirelessly. In the embodiment shown in FIG. 6, various wireless modules, each of which can correspond to a radio configured for a particular wireless communication protocol, are present. One manner for wireless communication in a short range such as a near field may be via a near field communication (NFC) unit 645 which may communicate, in one embodiment with processor 610 via an SMBus. Note that via this NFC unit 645, devices in close proximity to each other can communicate. For example, a user can enable system 600 to communicate with another (e.g.,) portable device such as a smartphone of the user via adapting the two devices together in close relation and enabling transfer of information such as identification information payment information, data such as image data or so forth. Wireless power transfer may also be performed using a NFC system.

As further seen in FIG. 6, additional wireless units can include other short range wireless engines including a WLAN unit 650 and a Bluetooth unit 652. Using WLAN unit 650, Wi-Fi™ communications in accordance with a given Institute of Electrical and Electronics Engineers (IEEE) 802.11 standard can be realized, while via Bluetooth unit 652, short range communications via a Bluetooth protocol can occur. These units may communicate with processor 610 via, e.g., a USB link or a universal asynchronous receiver transmitter (UART) link. Or these units may couple to processor 610 via an interconnect via a Peripheral Component Interconnect Express™ (PCIe™) protocol in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the next generation form factor (NGFF) connectors adapted to a motherboard.

In addition, wireless wide area communications, e.g., according to a cellular or other wireless wide area protocol, can occur via a WWAN unit 656 which in turn may couple to a subscriber identity module (SIM) 657. In addition, to enable receipt and use of location information, a GPS module 655 may also be present. Note that in the embodiment shown in FIG. 6, WWAN unit 656 and an integrated capture device such as a camera module 654 may communicate via a given USB protocol such as a USB 2.0 or 3.0 link, or a UART or I²C protocol. Again the actual physical connection of these units can be via adaptation of a NGFF add-in card to an NGFF connector configured on the motherboard.

To provide for audio inputs and outputs, an audio processor can be implemented via a digital signal processor (DSP) 660, which may couple to processor 610 via a high definition audio (HDA) link. Similarly, DSP 660 may communicate with an integrated coder/decoder (CODEC) and amplifier 662 that in turn may couple to output speakers 663 which may be implemented within the chassis. Similarly, amplifier and CODEC 662 can be coupled to receive audio inputs from a microphone 665 which in an embodiment can be implemented via dual array microphones to provide for high quality audio inputs to enable voice-activated control of various operations within the system. Note also that audio outputs can be provided from amplifier/CODEC 662 to a headphone jack 664. Although shown with these particular components in the embodiment of FIG. 6, understand the scope of the present invention is not limited in this regard.

In one or more embodiments, the system 600 may be configured to determine when to re-authenticate a user. The system 600 may include one or more trusted agents (not shown) that include corresponding trusted agent logic. Each trusted agent may monitor one or more corresponding identification parameters that may include any of, but are not limited to inertial and environmental sensors such as the accelerometer 641, the ambient light sensor (ALS) 642, the gyroscope 644, the one or more thermal sensors 646, and other sensors (not shown) that may include a low power camera, microphone, etc. and optionally using data pertaining to user typing characteristics, user access to secure files and to various networks, etc., as described herein. The system 600 may also include analysis logic to determine whether to re-authenticate a user based on parameter values received from the one or more trusted agents. The system 600 may include authentication logic (not shown) to re-authenticate the user through authentication data received from one or more authentication sensors (not shown) that may include, e.g., high resolution camera, iris biometric scanner, and/or other biometric data sensors. In one or more embodiments, the authentication logic may be remote authentication logic that receives authentication data from the one or more authentication sensors. In an embodiment, at least one of the authentication sensors is in a powered up state while the user is being re-authenticated and in a powered-down state after the user is re-authenticated and between re-authentications.

The following examples pertain to further embodiments. In an embodiment, a system includes one or more trusted agents each comprising trusted agent logic, each trusted agent to monitor a corresponding parameter based on input received from a respective sensor. The system also includes a processor including evaluation logic to determine whether to re-authenticate a user based on corresponding information received from the one or more trusted agents. The system also includes authentication logic to re-authenticate the user based on the determination provided by the evaluation logic. Re-authentication can include a confirmation of whether the user is authenticated based on input received from one or more authentication sensors. At least one of the authentication sensors is in a powered-up state while the user is being re-authenticated and in a powered-down state between consecutive instances of re-authentication.

In an embodiment, each of the trusted agents is to operate at a lower power consumption rate than at least one of the authentication sensors.

In an embodiment, a first trusted agent is to provide input based on corresponding data from a color sensor that is to monitor a first color intensity of a first color.

In an embodiment, the color sensor includes a single pixel camera.

In an embodiment, the evaluation logic is to determine whether to re-authenticate by calculation of a confidence level based on an analysis of the information received from the trusted agents and based on a comparison of the confidence level to a re-authentication threshold.

In an embodiment, the processor is further to determine whether to readjust the re-authentication threshold based on historical data that indicates a success rate of re-authentication.

In an embodiment, one of the trusted agents is to monitor a user typing pattern.

In an embodiment, one of the trusted agents is to monitor access to a network file of a network.

In an embodiment, the authentication logic is located in a remote backend server that is to communicate with the processor.

In an embodiment, a method includes determining, based on monitored parameter values of one or more trusted agents monitoring sensors of a system, whether to re-authenticate a user, and re-authenticating the user responsive to a determination to re-authenticate the user. Re-authenticating can include placing at least one authentication sensor of the system in a powered-up state, determining whether the user is confirmed as authenticated based on an evaluation of authentication parameter values received from one or more authentication sensors, and placing at least one of the one or more authentication sensors in a powered-down state after the re-authentication is complete until a subsequent determination to re-authenticate the user.

In an embodiment, the determination to re-authenticate the user is based on a comparison of a confidence level determined from one or more of the parameter values, to a threshold value.

In an embodiment, the confidence level is determined from a multi-factor analysis of the one or more parameter values.

In an embodiment, the method includes adjusting the threshold value based on a history of outcomes of re-authentication of the user.

In an embodiment, the re-authentication is conducted by remote authentication logic that communicates with a processor that includes the trusted agents.

In an embodiment, determining includes comparing a current typing parameter value at least partially characterizing a current typing pattern associated with the user, with another typing parameter value associated with another typing pattern.

In an embodiment, at least one machine accessible storage medium has instructions stored thereon that when executed on a machine, cause the machine to monitor corresponding parameter values of each of one or more trusted agents that receive data from corresponding sensors, to indicate, based on an evaluation of the monitored parameter values of one or more of the one or more trusted agents, whether to re-authenticate a user, and to conduct a re-authentication of the user responsive to an indication to re-authenticate the user. The re-authentication includes placement of one or more authentication sensors in a powered-up state, determination of whether the user is confirmed authenticated based on authentication parameter values received from the one or more authentication sensors, and placement of the authentication sensors in a powered-down state after completion of the determination until a subsequent indication to re-authenticate the user.

In an embodiment, the at least one machine accessible storage medium further includes instructions to monitor corresponding parameter values of one or more trusted agents by measurement of a first parameter value that at least partially characterizes a current typing pattern of the user.

In an embodiment, each sensor associated with a corresponding trusted agent has a lower power consumption than at least one of the one or more authentication sensors.

In an embodiment, the indication to re-authenticate the user is based on a comparison of a confidence level determined via a multi-factor analysis of the parameter values, to a threshold value.

In an embodiment, the at least one machine accessible storage medium includes instructions to adjust the threshold value based on a history of determinations of whether the user is re-authenticated.

In an embodiment, each sensor associated with a corresponding trusted agent has a lower power consumption than at least one of the one or more authentication sensors.

In an embodiment, a processor to re-authenticate a user includes evaluation logic to determine whether to re-authenticate a user based on corresponding information received from one or more trusted agents each including corresponding trusted agent logic, each trusted agent to monitor a corresponding parameter based on input received from a respective sensor. The processor also includes authentication logic to re-authenticate the user based on the determination provided by the evaluation logic. Re-authentication includes a confirmation of whether the user is authenticated based on input received from one or more authentication sensors. The authentication logic is to place at least one of the authentication sensors in a powered-up state while the user is being re-authenticated and in a powered-down state between consecutive instances of re-authentication.

In an embodiment, each of the trusted agents is to operate at a lower power consumption rate than at least one of the authentication sensors.

In an embodiment, a first trusted agent is to provide input based on corresponding data from a color sensor that is to monitor a first color intensity of a first color.

In an embodiment, the color sensor includes a single pixel camera.

In an embodiment one of the trusted agents is to monitor a user typing pattern.

In an embodiment, one of the trusted agents is to monitor access to a network file of a network.

In an embodiment, the evaluation logic is to determine whether to re-authenticate by calculation of a confidence level based on an analysis of the information received from the trusted agents and based on a comparison of the confidence level to a re-authentication threshold.

In an embodiment, the processor is further to determine whether to readjust the re-authentication threshold based on historical data that indicates a success rate of re-authentication.

Thus in various embodiments, user re-authentication for a web service may be performed at the client by use of low-power sensors to monitor user characteristics, e.g., weak biometrics, on an ongoing basis and to analyze sensor data to determine when to trigger re-authentication, which may reduce energy consumption over idle time-out techniques.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system comprising:
a processor including analysis logic to determine whether to re-authenticate a user based on information received from one or more agents; and
authentication logic to re-authenticate the user based on the determination provided by the analysis logic, wherein re-authentication includes a confirmation of whether the user is authenticated, the confirmation based on input received from one or more authentication sensors.

2. The system of claim 1, wherein each of the agents is to operate at a lower power consumption rate than at least one of the authentication sensors.

3. The system of claim 1, wherein a first agent is to provide input based on corresponding data from a color sensor that is to monitor a first color intensity of a first color.

4. The system of claim 3, wherein the color sensor includes a single pixel camera.

5. The system of claim 1, wherein the analysis logic is to determine whether to re-authenticate by calculation of a confidence level based on an analysis of the information received from the agents and based on a comparison of the confidence level to a re-authentication threshold.

6. The system of claim 5, wherein the calculation of the confidence level includes reduction of the confidence level responsive to an indication of at least one of a change in a color associated with the user and detected by a color sensor, an indication that access to confidential files by the user has increased, and an indication of a change in a use pattern of one of a keyboard, a touch screen, and a mouse input device.

7. The system of claim 5, wherein the processor is further to determine whether to readjust the re-authentication threshold based on historical data that associates one or more re-authentication threshold values with corresponding success rates of re-authentication.

8. The system of claim 1, wherein one of the agents is to monitor a user typing pattern.

9. The system of claim 1, wherein one of the agents is to monitor access to a network file of a network.

10. The system of claim 1, further comprising the one or more agents, each of the one or more agents comprising respective agent logic, each agent to monitor a corresponding parameter based on input received from a respective sensor.

11. The system of claim 1, wherein at least one of the authentication sensors is in a powered-up state while the user is being re-authenticated and in a powered-down state between consecutive instances of re-authentication.

12. A method comprising:
determining, based on monitored parameter values of one or more agents monitoring sensors of a system, whether to re-authenticate a user;
re-authenticating the user responsive to a determination to re-authenticate the user, wherein re-authenticating comprises:
placing at least one authentication sensor of the system in a powered-up state; and
determining whether the user is confirmed as authenticated based on an evaluation of authentication parameter values received from the at least one or authentication sensor; and
placing the at least one authentication sensor in a powered-down state after the re-authentication is complete until a subsequent determination to re-authenticate the user.

13. The method of claim 12, wherein the determination to re-authenticate the user is based on a comparison of a confidence level determined from one or more of the monitored parameter values, to a threshold value.

14. The method of claim 13, wherein the confidence level is determined from a multi-factor analysis of the one or more monitored parameter values.

15. The method of claim 13, further comprising adjusting the threshold value based on a history of outcomes of the re-authentication of the user.

16. The method of claim 12, wherein the re-authentication is conducted by remote authentication logic that communicates with a processor that includes the agents.

17. The method of claim 12, wherein the determining includes comparing a current typing parameter value at least partially characterizing a current typing pattern associated with the user, with another typing parameter value associated with another typing pattern.

18. At least one storage medium having instructions stored thereon for causing a system to:
monitor corresponding parameter values of each of one or more agents that receive data from corresponding sensors;
indicate, based on an evaluation of the monitored parameter values of one or more of the one or more agents, whether to re-authenticate a user; and
conduct a re-authentication of the user responsive to an indication to re-authenticate the user, wherein the re-authentication comprises:
placement of one or more authentication sensors in a powered-up state; and
determination of whether the user is confirmed as authenticated based on authentication parameter values received from the one or more authentication sensors; and
placement of the authentication sensors in a powered-down state after completion of the determination until a subsequent indication to re-authenticate the user.

19. The at least one storage medium of claim 18, further including instructions to monitor corresponding parameter values of one or more agents by measurement of a first parameter value that at least partially characterizes a current typing pattern of the user.

20. The at least one storage medium of claim 18, wherein the indication to re-authenticate the user is based on a comparison of a confidence level determined via a multi-factor analysis of the parameter values, to a threshold value.

21. The at least one storage medium of claim 20, further including instructions to adjust the threshold value based on a history of determinations of whether the user is re-authenticated.

22. The at least one storage medium of claim 18, wherein each sensor associated with a corresponding agent has a lower power consumption than at least one of the one or more authentication sensors.
